(19) United States
(12) Patent Application Publication
(10) Pub. No.: US 2024/0208298 A1
(43) Pub. Date: Jun. 27, 2024

(54) COOLING/HEATING VAPOR INJECTION SYSTEM AND VAPOR INJECTION SYSTEM MODULE USED THEREIN

(71) Applicant: Hanon Systems, Daejeon (KR)

(72) Inventors: Seong Hun KIM, Daejeon (KR); Yun Jin KIM, Daejeon (KR); Sung Je LEE, Daejeon (KR); Hae Jun LEE, Daejeon (KR)

(21) Appl. No.: 18/287,487

(22) PCT Filed: Oct. 13, 2022
(86) PCT No.: PCT/KR2022/015451

§ 371 Date: Oct. 19, 2023

(30) Foreign Application Priority Data
Oct. 21, 2021 (KR) 10-2021-0140901

(51) Int. Cl. B60H 1/00; B60H 1/22

(52) U.S. Cl. CPC B60H 1/00914; B60H 1/00385; B60H 1/2225

(57) ABSTRACT

The present invention provides a cooling/heating vapor injection system comprising: a compressor that compresses and circulates a refrigerant; a first branch part into which the compressed refrigerant is introduced to be branched; a first refrigerant line which is branched from the first branch part to allow the refrigerant to move therein, and has a condenser and a first expansion valve disposed therein; a second refrigerant line which is branched from the first branch part to allow the refrigerant to move therein, and has an indoor unit and a second expansion valve disposed therein; a gas-liquid separator into which the refrigerant passing through the 10 first refrigerant line or the second refrigerant line flows; and a second branch part into which the refrigerant passing through the gas-liquid separator flows, wherein the gas-liquid separator moves a liquid-phase refrigerant to the second branch part, and moves a gas-phase refrigerant to the compressor.

### TECHNICAL FIELD

Embodiments relate to a cooling/heating vapor injection system and a vapor injection module using the same. More specifically, embodiments relate to a cooling/heating vapor injection system implementing a cooling/heating system using one gas-liquid separator without a separate directional control valve, and a vapor injection module using the same.

### BACKGROUND ART

Under the trend of development of environmentally friendly industries and development of energy sources that replace fossil raw materials, areas that have recently attracted the most attention in the automobile industry are electric vehicles and hybrid vehicles. The electric vehicles and hybrid vehicles are equipped with batteries to provide a driving force, and the batteries are used not only for driving but also for cooling and heating.

In vehicles that provide a driving force using batteries, using the batteries as a heat source during cooling and heating means that a driving distance is reduced accordingly, and in order to overcome the above problem, a method of applying a heat pump system, which has been widely used as a home cooling and heating device, to vehicles has previously been suggested.

For reference, a heat pump refers to a device that absorbs low-temperature heat and transfers the absorbed heat to high-temperature heat. As one example, the heat pump has a cycle in which a liquid refrigerant evaporates in an evaporator, takes heat from the surroundings and becomes a gas, and then liquefies while releasing heat to the surroundings by a condenser. When the heat pump system is applied to an electric vehicle or hybrid vehicle, there is an advantage of securing a heat source, which is insufficient in a general air conditioning case in the related art.

The heat pump system uses a vapor injection system to increase cooling and heating performance. The vapor injection system has a structure that uses a gas-liquid separator in a refrigerant circulation system for heating and cooling, so that a gas-phase refrigerant is introduced back into a compressor and a liquid-phase refrigerant is supplied to an evaporator or a chiller.

However, referring to Japanese Patent Publication No. 2020-176824 (Prior Document 1), in which both cooling and heating are performed by using the aforementioned vapor injection system, a branch point is generated at the rear of an indoor unit and conversion between cooling and heating modes is performed using valves. However, in Prior Document 1, four directional control valves are structurally required.

In addition, referring to U.S. Patent Publication No. 2020-0039323 (Prior Document 2), for a vapor injection system that simultaneously performs heating and cooling, a structure requiring a plurality of directional control valves to simultaneously perform cooling and heating is disclosed.

As described above, in order to implement a system that performs cooling and heating using a single vapor injection system, a plurality of directional control valves are required, and this structure has the problem of complicating the system.

### Technical Problem

An embodiment is directed to providing a vapor injection system capable of using a minimum number of valves and simultaneously performing both cooling and heating.

Problems to be solved by present invention are not limited to those mentioned above, and other problems not mentioned will be clearly understood by those skilled in the art from the following description.

### Technical Solution

One aspect of the present invention provides a cooling/heating vapor injection system including a compressor configured to compress and circulate a refrigerant, a first branch part into which the compressed refrigerant is introduced to be branched, a first refrigerant line branched from the first branch part to allow the refrigerant to move therethrough and having a condenser and a first expansion valve disposed thereon, a second refrigerant line branched from the first branch part to allow the refrigerant to move therethrough and having an indoor unit and a second expansion valve disposed thereon, a gas-liquid separator into which the refrigerant passing through the first refrigerant line or the second refrigerant line is introduced, and a second branch part into which the refrigerant passing through the gas-liquid separator is introduced, and the gas-liquid separator moves a liquid-phase refrigerant to the second branch part and moves a gas-phase refrigerant to the compressor.

Preferably, the cooling/heating vapor injection may further include a third refrigerant line branched from the second branch part to allow the refrigerant to move therethrough and having a third expansion valve and an evaporator disposed thereon, a fourth refrigerant line branched from the second branch part to allow the refrigerant to move therethrough and having a fourth expansion valve and a chiller disposed thereon, and an accumulator configured to separate the refrigerant moving through the third refrigerant line or the fourth refrigerant line into a gas-phase refrigerant and a liquid-phase refrigerant and transmit the gas-phase refrigerant to the compressor.

Preferably, the refrigerant passing through the compressor may move to the first refrigerant line or the second refrigerant line through opening and closing of the first expansion valve or the second expansion valve.

Preferably, the liquid-phase refrigerant separated in the gas-liquid separator and moving to the second branch part may move to the third refrigerant line or the fourth refrigerant line through opening and closing of the third expansion valve or the fourth expansion valve.

Preferably, a check valve may be disposed in the fifth refrigerant line through which the gas-phase refrigerant separated in the gas-liquid separator is introduced into the compressor.

Preferably, the evaporator and the indoor unit may be disposed inside an air conditioning case, and a positive temperature coefficient (PTC) heater may be disposed inside the air conditioning case.

Preferably, in a heating mode, the first expansion valve may be closed and the second expansion valve may be opened so that the refrigerant passing through the compressor moves along the second refrigerant line and is introduced into the gas-liquid separator, and the third expansion valve may be opened and the fourth expansion valve may be closed so that the liquid-phase refrigerant passing through the gas-liquid separator moves along the third refrigerant line.

Preferably, in a cooling mode, the first expansion valve may be opened and the second expansion valve may be closed so that the refrigerant passing through the compressor moves along the first refrigerant line and is introduced into the gas-liquid separator, and the third expansion valve may be closed and the fourth expansion valve may be opened so that the liquid-phase refrigerant passing through the gas-liquid separator moves along the fourth refrigerant line.

Preferably, an air-cooled condenser or a water-cooled condenser may be used for the condenser.

Another aspect of the present invention provides a vapor injection module including a housing in which one check valve and first to fourth expansion valves are disposed, a gas-liquid separator disposed to face the housing, a first joining part connecting the first expansion valve and the second expansion valve with the gas-liquid separator, a second branch part connecting the third expansion valve and the fourth expansion valve with the gas-liquid separator, and a fifth refrigerant line connecting the check valve and the gas-liquid separator.

Preferably, a refrigerant introduced into the gas-liquid separator through the first joining part may be separated into a gas-phase refrigerant and a liquid-phase refrigerant inside the gas-liquid separator, the separated gas-phase refrigerant may move to the fifth refrigerant line, and the separated liquid-phase refrigerant may move to the second branch part.

Preferably, in a heating mode, the first expansion valve may be opened and the second expansion valve may be closed so that the refrigerant passing through the first expansion valve is introduced into the gas-liquid separator through the first joining part, the gas-phase refrigerant separated in the gas-liquid separator may move to the fifth refrigerant line and the liquid-phase refrigerant moves to the second branch part, and the third expansion valve may be closed and the fourth expansion valve may be opened so that the liquid-phase refrigerant introduced into the second branch part passes through the fourth expansion valve.

Preferably, in a cooling mode, the first expansion valve may be closed and the second expansion valve may be opened so that the refrigerant passing through the second expansion valve is introduced into the gas-liquid separator through the first joining part, the gas-phase refrigerant separated in the gas-liquid separator may move to the fifth refrigerant line and the liquid-phase refrigerant moves to the second branch part, and the third expansion valve may be opened and the fourth expansion valve may be closed so that the liquid-phase refrigerant introduced into the second branch part passes through the third expansion valve.

### Advantageous Effects

According to an embodiment, there is an effect of using cooling and heating vapor injection technology with one-time cost investment.

In addition, there is an effect of reducing costs and simplifying a system structure by minimizing the number of valves for performing cooling and heating with a single vapor injection system.

Various beneficial advantages and effects of the present invention are not limited by the contents described above and should be easily understood through a description of a detailed embodiment of the present invention.

### BRIEF DESCRIPTION OF THE DRAWINGS

FIG. 1 is a diagram illustrating a structure of a cooling/heating vapor injection system according to one embodiment of the present invention.

FIG. 2 is a diagram illustrating a flow of a refrigerant in a cooling mode in FIG. 1.

FIG. 3 is a diagram illustrating a flow of the refrigerant in a heating mode in FIG. 1.

FIG. 4 is a diagram illustrating a structure of a vapor injection module according to another embodiment of the present invention.

FIG. 5 is a diagram illustrating a position of the vapor injection module illustrated in FIG. 4 in the system of FIG. 1.

FIG. 6 is a diagram illustrating a flow of a refrigerant in a heating mode of FIG. 4.

FIG. 7 is a diagram illustrating a flow of the refrigerant in a cooling mode of FIG. 4.

### MODES OF THE INVENTION

Hereinafter, preferred embodiments of the present invention will be described in detail with reference to the accompanying drawings.

However, the technical idea of the present invention is not limited to some embodiments to be described but may be implemented in various different forms, and, within the scope of the technical idea of the present invention, one or more among components in the embodiments may be used by being selectively combined and substituted.

Further, unless specifically defined and described, terms used in the embodiments of the present invention (including technical and scientific terms) may be construed as meanings which are generally understood by those skilled in the art to which the present invention pertains, and commonly used terms such as terms defined in the dictionary may be interpreted in consideration of the contextual meaning of the related art.

The terms used in the embodiments of the present invention are for the purpose of describing the embodiments only and are not intended to limit the invention.

In the present specification, the singular forms may include the plural forms unless the context clearly dictates otherwise, and, when described as “at least one (or one or more) among A, B, and (or) C,” it may include one or more of all possible combinations of A, B, and C.

In addition, in describing a component of embodiments of the present invention, terms such as first, second, A, B, (a), (b), etc. may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but identical or corresponding components are denoted by the same reference numerals regardless of figure numbers, and redundant descriptions thereof will be omitted.

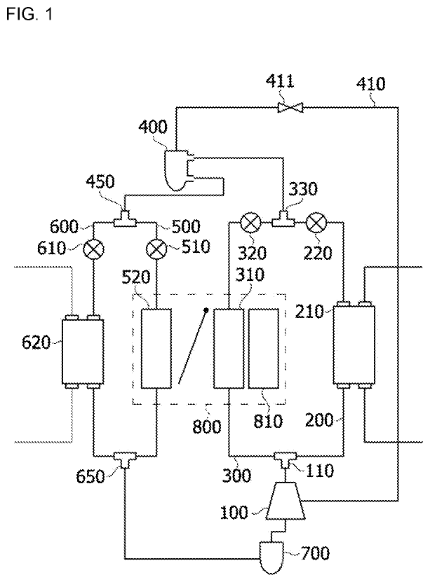

FIGS. 1 to 7 clearly illustrate only main features in order to clearly understand the present invention conceptually, and as a result, various modifications of the illustrations are expected, and the scope of the present invention need not be limited by specific shapes shown in the drawings.

FIG. 1 is a diagram illustrating a structure of a cooling/heating vapor injection system according to one embodiment of the present invention.

Referring to FIG. 1, the cooling/heating vapor injection system according to the embodiment of the present invention includes a compressor 100, a first refrigerant line 200, a second refrigerant line 300, a gas-liquid separator 400, a third refrigerant line 500, a fourth refrigerant line 600, and an accumulator 700.

The compressor 100 may compress and circulate a refrigerant. The compressor 100 is driven by receiving power from an engine (internal combustion engine), a motor, or the like to suck the refrigerant, compress the sucked refrigerant, and discharge the compressed refrigerant to a first branch part 110 in a high-temperature, high-pressure gaseous state.

The first branch part 110 may receive the compressed refrigerant from the compressor 100 and the refrigerant may branch in the first branch part 110. The refrigerant moving to the first branch part 110 may be separated in the first branch part 110 and introduced into the first refrigerant line 200 and the second refrigerant line 300. In this case, movement of refrigerant to the first refrigerant line 200 and the second refrigerant line 300 may be controlled by opening or closing an expansion valve disposed in each of the refrigerant lines.

Through the first refrigerant line 200, the refrigerant branched from the first branch part 110 may move, and a condenser and a first expansion valve 220 may be disposed in the first refrigerant line 200.

A condenser 210 may condense the refrigerant compressed through the compressor 100. The condenser 210 may be an air-cooled condenser 210 or a water-cooled condenser 210. When the water-cooled condenser 210 is used, condensation may be performed through heat exchange with coolant moving through a coolant circulation line of a vehicle.

The first expansion valve 220 may be disposed at an outlet side of the condenser 210 and perform expansion, flow control, and opening/closing functions of the refrigerant.

Through the second refrigerant line 300, the refrigerant branched from the first branch part 110 may move, and an indoor unit 310 and a second expansion valve 320 may be disposed in the second refrigerant line 300.

The indoor unit 310 may be installed in an air conditioning case 800 disposed inside the vehicle, and the indoor unit 310 may function to heat the interior using heat radiated from the refrigerant discharged from the compressor 100 by exchanging heat between the refrigerant and blown air.

In addition, a positive temperature coefficient (PTC) heater may be disposed inside the air conditioning case 800 of the vehicle. The PTC heater 810 may be disposed inside the air conditioning case 800 together with the indoor unit 310 and used as a means for heating the air, and may be used as a means for supplementing the indoor unit 310 when the temperature required for vehicle air conditioning is not met by the indoor unit 310.

The second expansion valve 320 may be disposed on at outlet side of the indoor unit 310 and may perform expansion, flow control, and opening/closing functions of the refrigerant.

The first expansion valve 220 and the second expansion valve 320 may be opened and closed according to air conditioning modes, and may control a movement line of the refrigerant.

The refrigerant passing through the compressor 100 may be depressurized and expanded while passing through the first expansion valve 220 or the second expansion valve 320, and move to the first branch part 110.

The gas-liquid separator 400 may separate the refrigerant passing through the first branch part 110 into a gas-phase refrigerant and a liquid-phase refrigerant, move the liquid-phase refrigerant of the separated refrigerants to a second branch part 450, and reintroduce the gas-phase refrigerant into the compressor 100.

The gas-liquid separator 400 functions to separate the refrigerant into gas phase and liquid phase, like the accumulator 700 disposed before the refrigerant is circulated through the refrigerant line and introduced into the compressor 100. However, there is a difference between the accumulator 700 and the gas-liquid separator 400 in that the accumulator 700 supplies the gas-phase refrigerant to the compressor 100, whereas the gas-liquid separator 400 allows the separated liquid-phase refrigerant to flow as it is.

The fifth refrigerant line 410, through which the gas-phase refrigerant separated in the gas-liquid separator 400 is reintroduced into the compressor 100, may be provided with a check valve 411.

The check valve 411 disposed in the fifth refrigerant line 410 may control movement of the gas-phase refrigerant moving through the fifth refrigerant line 410 as needed.

In the second branch part 450, the liquid-phase refrigerant passing through the gas-liquid separator 400 may move, and in the second branch part 450, the third refrigerant line 500 and the fourth refrigerant line 600 may be branched.

The third refrigerant line 500 may allow the liquid-phase refrigerant separated in the gas-liquid separator 400 to move therethrough and have a third expansion valve 510 and an evaporator 520 disposed thereon.

The third expansion valve 510 may be disposed at an inlet side of the evaporator 520 and perform expansion, flow control, and opening/closing functions of the refrigerant.

The evaporator 520 may be disposed inside the air conditioning case 800 together with the indoor unit 310 to perform cooling and heating of the interior of the vehicle. The evaporator 520 is supplied with a low-temperature, low-pressure refrigerant discharged from the third expansion valve 510, and air flowing inside the air conditioning case 800 by a blower turns into cold air by exchanging heat with the low-temperature, low-pressure refrigerant inside the evaporator 520 in a process of passing through the evaporator 520 and then is discharged into the interior of the vehicle, thereby cooling the interior of the vehicle.

The fourth refrigerant line 600 may allow the liquid-phase refrigerant separated in the gas-liquid separator 400 to move therethrough and have a fourth expansion valve 610 and a chiller 620 disposed thereon.

The fourth expansion valve 610 may be disposed at an inlet side of the chiller 620 and perform expansion, flow control, and opening/closing functions of the refrigerant.

The chiller 620 may be supplied with a low-temperature, low-pressure refrigerant discharged from the fourth expansion valve 610 so that heat exchange with coolant moving through a coolant line of an air conditioning system for vehicles is performed. The coolant cooled while passing through the chiller 620 may cool heat-generating parts such as a battery of the vehicle.

The accumulator 700 may be installed on a refrigerant circulation line at an inlet side of the compressor 100, where the refrigerant passing through the evaporator 520 and/or chiller 620 joins, and may separate the liquid-phase refrigerant and the gas-phase refrigerant in the refrigerant, supply only the gas-phase refrigerant to the compressor 100, and store excess refrigerant. A suction port of the compressor 100 may be connected to a gas-phase refrigerant outlet of the accumulator 700, thereby preventing the liquid-phase refrigerant from being sucked into the compressor 100.

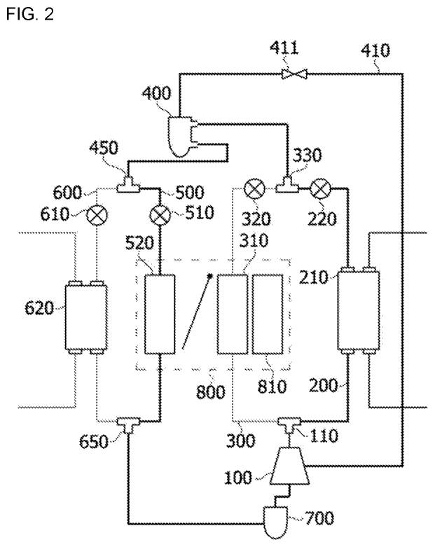

FIG. 2 is a diagram illustrating a flow of a refrigerant in a cooling mode in FIG. 1.

Referring to FIG. 2, as the compressor 100 operates on the refrigerant circulation line in the cooling mode, a high-temperature, high-pressure refrigerant is discharged from the compressor 100. The refrigerant discharged from the compressor 100 moves to the first branch part 110.

In the cooling mode, the first expansion valve 220 is opened and the second expansion valve 320 is closed so that the refrigerant discharged from the compressor 100 moves along the first refrigerant line 200. The refrigerant discharged from the compressor 100 is introduced into the condenser 210, and the refrigerant condensed while passing through the condenser 210 is firstly depressurized and expanded while passing through the first expansion valve 220 and moves.

Then, the refrigerant passing through the first joining part 330 may be introduced into the gas-liquid separator 400, the liquid-phase refrigerant separated in the gas-liquid separator 400 may move to the second branch part 450, and the gas-phase refrigerant may be reintroduced into the compressor 100.

The third expansion valve 510 is opened and the fourth expansion valve 610 is closed so that the liquid-phase refrigerant passing through the second branch part 450 moves along the third refrigerant line 500.

The liquid-phase refrigerant is secondarily expanded and depressurized while moving along the third expansion valve 510 and moves, the refrigerant that has been expanded and depressurized evaporates by exchanging heat with air blown by a blower (not illustrated) of the air conditioning case 800 while passing through the evaporator 520, thereby cooling the air, the cooled air is supplied to the interior of the vehicle, and thus the interior of the vehicle is cooled.

Further, the refrigerant evaporated in the evaporator 520 is introduced back into the compressor 100 through the accumulator 700.

In addition, for the cooling mode, there may be a case where the fourth expansion valve 610 is opened together with the third expansion valve 510. In this case, the refrigerant expanded while passing through the fourth expansion valve 610 may evaporate by exchanging heat with the coolant while passing through the chiller 620, thereby cooling the coolant. In addition, the refrigerant evaporated in the chiller 620 may be circulated by being introduced back into the compressor 100 through the accumulator 700 and through the joining part 650.

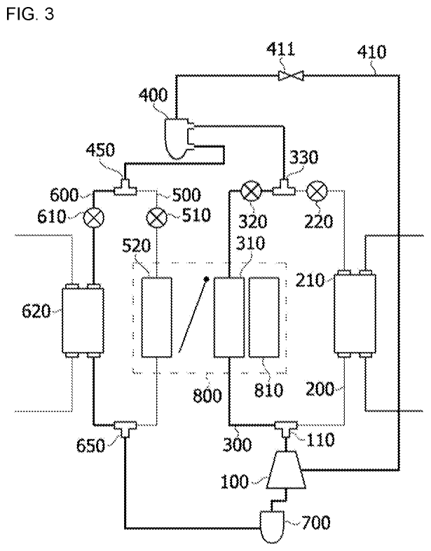

FIG. 3 is a diagram illustrating a flow of the refrigerant in a heating mode in FIG. 1.

Referring to FIG. 3, as the compressor 100 operates on the refrigerant circulation line in the heating mode, a high-temperature, high-pressure refrigerant is discharged from the compressor 100. The refrigerant discharged from the compressor 100 moves to the first branch part 110.

In the heating mode, the first expansion valve 220 is closed and the second expansion valve 320 is opened so that the refrigerant discharged from the compressor 100 moves along the second refrigerant line 300. The refrigerant discharged from the compressor 100 is introduced into the indoor unit 310, the refrigerant passing through the indoor unit 310 is heated by exchanging heat with the air blown by the blower (not illustrated) of the air conditioning case 800, the heated air is supplied to the interior of the vehicle, and thus the interior of the vehicle is cooled.

In this case, when temperature required by an air-conditioning wind that has exchanged heat with the indoor unit 310 is not met by the indoor unit 310, the PTC heater 810 may be started up so that the air-conditioning wind is heated to the required temperature, and the heated air-conditioning wind may be supplied to the interior of the vehicle.

Then, after passing the second expansion valve 320, the refrigerant that has been firstly expanded may be introduced into the gas-liquid separator 400, the liquid-phase refrigerant separated in the gas-liquid separator 400 may move to the second branch part 450, and the gas-phase refrigerant may be reintroduced into the compressor 100.

The third expansion valve 510 is closed and the fourth expansion valve 610 is opened so that the liquid-phase refrigerant passing through the second branch part 450 moves along the fourth refrigerant line 600.

The refrigerant expanded while passing through the fourth expansion valve 610 may evaporate by exchanging heat with the coolant while passing through the chiller 620, thereby cooling the coolant. In addition, the refrigerant evaporated in the chiller 620 may be circulated by being introduced back into the compressor 100 through the accumulator 700 and through the joining part 650.

The embodiment of the present invention unifies the position of the rear end of the condenser 210 in cooling and heating by not using an outdoor unit as a heat absorbing device for heating, and in this way, a cooling and heating system may be implemented using a single gas-liquid separator 400 without using a separate directional control valve.

Meanwhile, hereinafter, a vapor injection module 1000 according to another embodiment of the present invention will be described with reference to the accompanying drawings as follows. However, the description of the same items as described in the cooling/heating vapor injection system according to one embodiment of the present invention will be omitted.

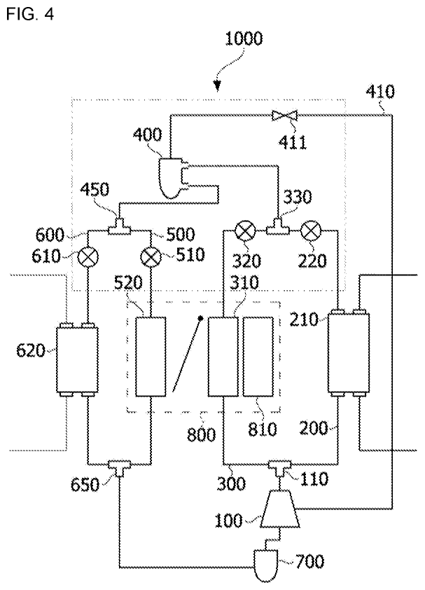

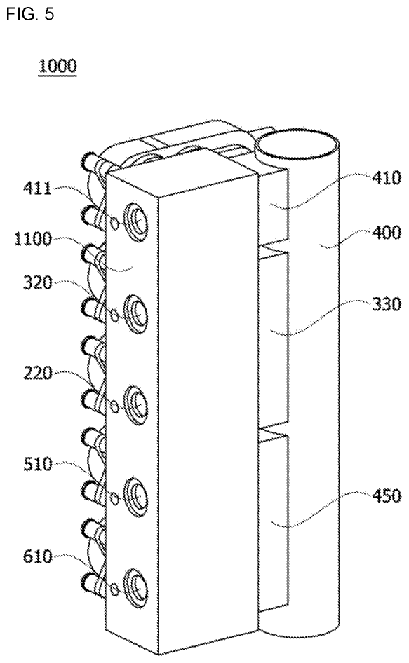

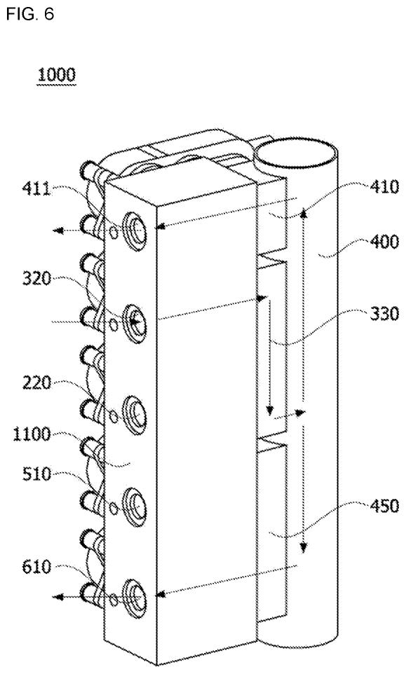

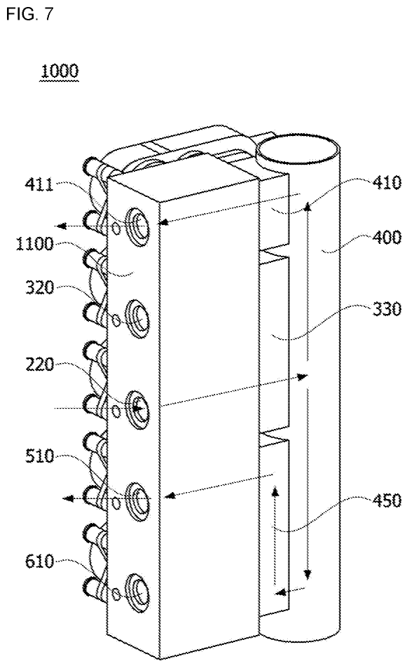

FIG. 4 is a diagram illustrating a structure of the vapor injection module 1000 according to another embodiment of the present invention, FIG. 5 is a diagram illustrating a position of the vapor injection module 1000 illustrated in FIG. 4 in the system of FIG. 1, FIG. 6 is a diagram illustrating a flow of a refrigerant in a heating mode of FIG. 4, and FIG. 7 is a diagram illustrating a flow of the refrigerant in a cooling mode of FIG. 4.

In the description of FIGS. 4 to 7, the same reference numerals as those in FIGS. 1 to 3 indicate the same members, and detailed descriptions thereof will be omitted.

Referring to FIGS. 4 to 7, the vapor injection module 1000 according to the other embodiment of the present invention may include a housing 1100, a gas-liquid separator 400, a first joining part 330, a second branch part 450, and a fifth refrigerant line 410.

The housing 1100 may provide a space where one check valve 411 and first to fourth expansion valves 610 are disposed. In one embodiment, the housing 1100 may be provided in the shape of a square pillar, and the check valve 411 and the first to fourth expansion valves 610 may be arranged in a longitudinal direction. This longitudinal arrangement structure may be a structure for communication between the check valve 411 and the gas-liquid separator 400 through which the first to fourth expansion valves 610 pass, thereby maximizing space utilization.

The first to fourth expansion valves 610 disposed inside the housing 1100 may use various known expansion valve structures for expanding an introduced refrigerant. In one embodiment, for the first to fourth expansion valves 610, a ball valve structure may be used.

The gas-liquid separator 400 may be disposed to face the housing 1100. The gas-liquid separator 400 may separate the refrigerant introduced through a first expansion valve 220 and the second expansion valve 320 into a gas-phase refrigerant and a liquid-phase refrigerant. In order to smoothly transfer the refrigerant separated through the gas-liquid separator 400, a third expansion valve 510 and the fourth expansion valve 610 through which the liquid-phase refrigerant moves may be connected to a lower end of the gas-liquid separator 400, the check valve 411 through which the gas-phase refrigerant moves may be connected to an upper end of the gas-liquid separator 400, and the first expansion valve 220 and the second expansion valve 320 may be connected to the gas-liquid separator 400 between the check valve 411 and the third expansion valve 510 and the fourth expansion valve 610.

The first joining part 330 may be disposed in one region of a central area of the gas-liquid separator 400, and connect the first expansion valve 220 and the second expansion valve 320 to the gas-liquid separator 400.

The first joining part 330 may be connected to the first expansion valve 220 and the second expansion valve 320, and may introduce the refrigerant moving along the first refrigerant line 200 or the second refrigerant line 300 into the gas-liquid separator 400 depending on whether the first expansion valve 220 and the second expansion valve 320 are opened or closed.

The second branch part 450 may be disposed on a lower side of the gas-liquid separator 400, that is, on a lower side of the first joining part 330, and may connect the third expansion valve 510 and the fourth expansion valve 610 to the gas-liquid separator 400.

In the second branch part 450, a liquid-phase refrigerant separated from the gas-liquid separator 400 may move to a third refrigerant line 500 or a fourth refrigerant line 600 depending on whether the third expansion valve 510 and the fourth expansion valve 610 are opened or closed.

The fifth refrigerant line 410 may be disposed on an upper side of the gas-liquid separator 400, that is, on an upper side of the first joining part 330, and may connect the check valve 411 and a refrigerant movement passage. The fifth refrigerant line 410 may allow a gas-phase refrigerant separated from the gas-liquid separator 400 to be introduced into the compressor 100 depending on whether the check valve 411 is opened or closed.

Looking at flow in the structure, the refrigerant introduced into the gas-liquid separator 400 through the first joining part 330 is divided into the gas-phase refrigerant and the liquid-phase refrigerant inside the gas-liquid separator 400, and the separated gas-phase refrigerant moves to the fifth refrigerant line 410, and the separated liquid-phase refrigerant moves to the second branch part 450.

Referring to FIG. 6, for the heating mode, the first expansion valve 220 is opened and the second expansion valve 320 is closed so that the refrigerant passing through the first expansion valve 220 is introduced into the gas-liquid separator 400 through the first joining part 330 and the gas-phase refrigerant separated in the gas-liquid separator 400 moves to the fifth refrigerant line 410. In this case, the liquid-phase refrigerant moves to the second branch part 450, and the third expansion valve 510 is closed and the fourth expansion valve 610 is opened so that the liquid-phase refrigerant introduced into the second branch part 450 passes through the fourth expansion valve 610 and moves to the fourth refrigerant line 600.

Referring to FIG. 7, for the cooling mode, the first expansion valve is closed and the second expansion valve 320 is opened so that the refrigerant passing through the second expansion valve 320 is introduced into the gas-liquid separator 400 through the first joining part 330 and the gas-phase refrigerant separated in the gas-liquid separator 400 moves to the fifth refrigerant line 410. In this case, the liquid-phase refrigerant moves to the second branch part 450, and the third expansion valve 510 is opened and the fourth expansion valve 610 is closed so that the liquid-phase refrigerant introduced into the second branch part 450 passes through the third expansion valve 510 and moves to the third refrigerant line 500.

The embodiments of the present invention have been specifically described above with reference to the accompanying drawings.

The above description is merely illustrative of the technical idea of the present invention, and those of ordinary skill in the art to which the present invention pertains will be able to make various modifications, variations, and substitutions without departing from the essential characteristics of the present invention. Accordingly, the embodiments disclosed in the present invention and the accompanying drawings are not intended to limit the technical idea of the present invention but to explain the technical idea, and the scope of the technical idea of the present invention is not limited by these embodiments and drawings. The scope of protection of the present invention should be interpreted by the accompanying claims, and all technical ideas within the scope equivalent thereto should be construed as being included in the scope of the present invention.

### REFERENCE SIGNS LIST

100: Compressor

110: First branch part

200: First refrigerant line

210: Condenser

220: First expansion valve

300: Second refrigerant line

310: Indoor unit

320: Second expansion valve

330: First joining part

400: Gas-liquid separator

410: Fifth refrigerant line

411: Check valve

450: Second branch part

500: Third refrigerant line

510: Third expansion valve

520: Evaporator

600: Fourth refrigerant line

610: Fourth expansion valve

620: Chiller

650: Second joining part

700: Accumulator

800: Air conditioning case

810: PTC heater

1000: Vapor injection module

1100: Housing

What is claimed is:

1. A cooling/heating vapor injection system comprising:
a compressor configured to compress and circulate a refrigerant;
a first branch part into which the compressed refrigerant is introduced to be branched;
a first refrigerant line branched from the first branch part to allow the refrigerant to move therethrough and having a condenser and a first expansion valve disposed thereon;
a second refrigerant line branched from the first branch part to allow the refrigerant to move therethrough and having an indoor unit and a second expansion valve disposed thereon;
a gas-liquid separator into which the refrigerant passing through the first refrigerant line or the second refrigerant line is introduced; and
a second branch part into which the refrigerant passing through the gas-liquid separator is introduced,
wherein the gas-liquid separator moves a liquid-phase refrigerant to the second branch part and moves a gas-phase refrigerant to the compressor.

2. The cooling/heating vapor injection system of claim 1, further comprising:
a third refrigerant line branched from the second branch part to allow the refrigerant to move therethrough and having a third expansion valve and an evaporator disposed thereon;
a fourth refrigerant line branched from the second branch part to allow the refrigerant to move therethrough and having a fourth expansion valve and a chiller disposed thereon; and
an accumulator configured to separate the refrigerant moving through the third refrigerant line or the fourth refrigerant line into a gas-phase refrigerant and a liquid-phase refrigerant and transmit the gas-phase refrigerant to the compressor.

3. The cooling/heating vapor injection system of claim 2, wherein the refrigerant passing through the compressor moves to the first refrigerant line or the second refrigerant line through opening and closing of the first expansion valve or the second expansion valve.

4. The cooling/heating vapor injection system of claim 2, wherein the liquid-phase refrigerant separated in the gas-liquid separator and moving to the second branch part moves to the third refrigerant line or the fourth refrigerant line through opening and closing of the third expansion valve or the fourth expansion valve.

5. The cooling/heating vapor injection system of claim 2, wherein a check valve is disposed in the fifth refrigerant line through which the gas-phase refrigerant separated in the gas-liquid separator is introduced into the compressor.

6. The cooling/heating vapor injection system of claim 2, wherein the evaporator and the indoor unit are disposed inside an air conditioning case, and
a positive temperature coefficient (PTC) heater is disposed inside the air conditioning case.

7. The cooling/heating vapor injection system of claim 2, wherein in a heating mode,
the first expansion valve is closed and the second expansion valve is opened so that the refrigerant passing through the compressor moves along the second refrigerant line and is introduced into the gas-liquid separator, and
the third expansion valve is opened and the fourth expansion valve is closed so that the liquid-phase refrigerant passing through the gas-liquid separator moves along the third refrigerant line.

8. The cooling/heating vapor injection system of claim 2, wherein in a cooling mode,
the first expansion valve is opened and the second expansion valve is closed so that the refrigerant passing through the compressor moves along the first refrigerant line and is introduced into the gas-liquid separator, and
the third expansion valve is closed and the fourth expansion valve is opened so that the liquid-phase refrigerant passing through the gas-liquid separator moves along the fourth refrigerant line.

9. The cooling/heating vapor injection system of claim 2, wherein an air-cooled condenser or a water-cooled condenser is used for the condenser.

10. A vapor injection module comprising:
a housing in which one check valve and first to fourth expansion valves are disposed;
a gas-liquid separator disposed to face the housing;
a first joining part connecting the first expansion valve and the second expansion valve with the gas-liquid separator;
a second branch part connecting the third expansion valve and the fourth expansion valve with the gas-liquid separator; and
a fifth refrigerant line connecting the check valve and the gas-liquid separator.

11. The vapor injection module of claim 10, wherein a refrigerant introduced into the gas-liquid separator through the first joining part is separated into a gas-phase refrigerant and a liquid-phase refrigerant inside the gas-liquid separator,
the separated gas-phase refrigerant moves to the fifth refrigerant line, and
the separated liquid-phase refrigerant moves to the second branch part.

12. The vapor injection module of claim 11, wherein in a heating mode,
the first expansion valve is opened and the second expansion valve is closed so that the refrigerant passing through the first expansion valve is introduced into the gas-liquid separator through the first joining part,
the gas-phase refrigerant separated in the gas-liquid separator moves to the fifth refrigerant line and the liquid-phase refrigerant moves to the second branch part, and
the third expansion valve is closed and the fourth expansion valve is opened so that the liquid-phase refrigerant introduced into the second branch part passes through the fourth expansion valve.

13. The vapor injection module of claim 11, wherein in a cooling mode,
the first expansion valve is closed and the second expansion valve is opened so that the refrigerant passing through the second expansion valve is introduced into the gas-liquid separator through the first joining part,
the gas-phase refrigerant separated in the gas-liquid separator moves to the fifth refrigerant line and the liquid-phase refrigerant moves to the second branch part, and
the third expansion valve is opened and the fourth expansion valve is closed so that the liquid-phase refrigerant introduced into the second branch part passes through the third expansion valve.
